(19) United States
(12) Patent Application Publication
(10) Pub. No.: US 2006/0287740 A1
(43) Pub. Date: Dec. 21, 2006

(54) Monitoring system for support of customer-specific configuration of remote devices

(76) Inventor: Emilian Ertel, Nurnberg (DE)

Correspondence Address: SCHIFF HARDIN, LLP;PATENT DEPARTMENT, 6600 SEARS TOWER, CHICAGO, IL, 60606-6473, US

(21) Appl. No.: 11/157,410

(22) Filed: Jun. 21, 2005

(51) Int. Cl. G05B 15/02; G05B 19/18

(52) U.S. Cl. 700/65; 700/66; 700/9

(57) ABSTRACT

A method and system for providing generic configuration parameter values and criteria-specific parameter values to a remote device by a centralized system, comprises generating a template having generic configuration parameter values as well as criteria-specific configuration parameter values based on a predetermined criteria, and updating a parameter in the remote device according to the criteria-specific configuration parameter values if the device meets the predetermined criteria, and according to the generic configuration parameter values otherwise. Events generated by the remote device are filtered according to both the generic parameter values and the criteria-specific parameter values prior to being sent (or not sent) to the centralized system. Additionally, other activities taking place on the remote device can be taken dependent on the settings of these parameter values.

### BACKGROUND OF THE INVENTION

The present invention is directed to a system and appertaining method for centrally monitoring the status of remote devices.

In order to centrally determine the status of various remote devices, such as medical apparatuses, each medical apparatus may be equipped with a locally-installed status monitoring application that can forward status information via messages to a centralized location/system and take on other system activities. The messages can serve both for monitoring and also for proactive detection of errors that can occur during operation.

The configuration of the status monitoring application associated with a particular apparatus is product-specific, but generally, the same configuration will be used for a specific type or model. The configuration can be designed so that it is remotely distributed to all installed systems by the centralized system at any time.

The configuration may implement an event template or set of rules that functions similar to a filter, i.e., it determines which messages should be forwarded by the local system (for example, which events from a Windows Event Log) to the centralized system or which action should be initiated in case of a failure. A template is hereby defined as any file set of rules, program, or other mechanism that can be utilized for the purposes of parameter configuration.

However, there is presently no support for a customer-specific configuration, meaning it is not possible to issue templates that differ by customer. This is problematic because it implies that important events either have to be discarded entirely (because a system produces too many events), or that additional events cannot be enabled for one particular customer because they would thereby also be enabled at all other customers. Accordingly, systems utilizing a single modality, which defines a particular set of hardware and/or software from one source or product/series, would all have a common event template or set of rules.

However, a particular product or system may, e.g., be able to run on various hardware platforms. There is therefore the need to be able to specifically configure the event template or set of rules for each individual customer installation in order to be able to optimally flexibly define local events that should be forwarded to the centralized system. For example, given twenty client computers, it should be possible that each of the clients has a status monitoring application (event template or set of rules) that is configured differently than the other status monitoring applications for a particular product or system.

### SUMMARY

The invention is directed to a method for providing generic configuration parameter values and criteria-specific parameter values to a remote device by a centralized system, comprising: generating a template comprising generic configuration parameter values as well as criteria-specific configuration parameter values based on a predetermined criteria; updating a parameter in the remote device according to the criteria-specific configuration parameter values if the device meets the predetermined criteria, and according to the generic configuration parameter values otherwise; generating an event by the remote device; determining one or more actions to take with respect to the event based on the parameter value that may be either a generic configuration parameter value or a criteria-specific configuration parameter value; and sending the event by the remote device to the centralized system if the one or more actions include an action of sending the event to the centralized system.

The invention can also broadly consider other operations according to the criteria-specific configuration parameter values, such as customizing a restart policy, that may, for example, involve a watchdog application.

The invention is also directed to a system for monitoring the status of remote devices, comprising: a centralized system comprising a template containing generic configuration parameter values as well as criteria-specific configuration parameter values based on a predetermined criteria; a remote device attached to the centralized system via a communications link; a communication module configured to move the template from the centralized system to the remote device via the communications link; a configuration reader having an input for receiving the template and configured to update a parameter in the remote device according to the criteria-specific configuration parameter values if the device meets the predetermined criteria, and according to the generic configuration parameter values otherwise; an event generator of the remote device that generates events related to the remote device; a filter mechanism configured to determine one or more actions to take with respect to the event based on the parameter value that may be either a generic configuration parameter value or a criteria-specific configuration parameter value; and a transmitter for sending the event by the remote device to the centralized system if the one or more actions include an action of sending the event to the centralized system.

Accordingly, it is provided that the configurations for the apparatuses that are distributed contain not only the configuration data directed for the type of apparatus, but rather additionally also contain a product ID or serial number for which these configuration data are applicable and optionally, or alternately, information identifying another characteristic of the apparatuses. Upon reading the configuration data into this medical product or apparatus with a specific product ID, using the read configuration data/ID and the local ID (or information related to another characteristic), a configuration reader decides which configuration is to be loaded.

This solution is possible to implement for all already-installed systems. Only the processing unit that reads in the event template must be changed (and this can also be remotely distributed). Such a solution may be utilized by, e.g., service engineers who like to customize the messages that are sent from a particular apparatus or groups of apparatuses to the centralized system.

This solution increases flexibility because it permits customization of individual systems without effecting the change on other installed systems, and this can be centrally distributed from a centralized location even for customer-specific solutions or attribute limited solutions. This allows an easier parallel development of systems and a mostly automatic merging of parameters. An installed base of apparatuses is easier to manage and thereby has a more flexible configuration.

Individual software can be utilized to keep track of which parameters can be updated on the systems and in which combination. A series of auxiliary programs, such as editors or other types of programs, may allow the customer to produce a technical environment according to its own requirements. The software can replace a portion of the existing technical software of the infrastructure. However, at the same time the software allows much of the remaining software to run as before.

The system can also permit a transparent software configuration system device in which the customers can see a view over all changes that have been made. Such a historical database of transfers can be created so that one can maintain a transfer history and change back to the old configuration at any time by requesting the use of the old configuration. A history file (which is defined as a literal file or a database of any sort) can comprise all old and new versions of templates along with possibly an index for identifying the old and new versions.

The system can utilize an extensible database via which: 1) a new ID can be attached and new parameters defined for every new device; 2) new common parameters for all devices can be defined, including parameters that correspond to the new update technology; and 3) interactions for new features can be defined. The system can also utilize a flexible query help program.

### DESCRIPTION OF THE DRAWINGS

The following Figures illustrate an embodiment of the invention.

FIG. 1 is a block diagram illustrating multiple medical apparatuses having readers connected to a central system;

FIG. 2 is a block diagram illustrating a process flow of an exemplary embodiment of the invention; and

FIG. 3 is a block diagram illustrating the use of different characteristic attributes and appertaining grouping.

### DETAILED DESCRIPTION OF THE PREFERRED EMBODIMENTS

An embodiment of the invention is described in more detail below with reference to the Figures.

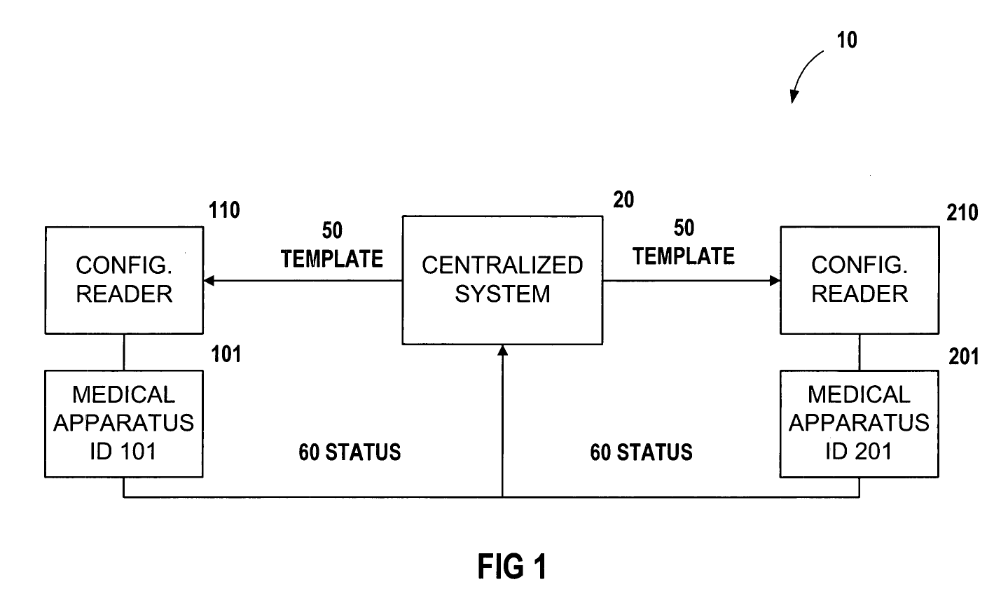

FIG. 1 shows a reporting system 10 having a centralized status system 20 to which status information 60 from various medical apparatuses 101, 201 is sent. Each medical apparatus 101, 201 has an associated configuration reader 110, 210 configured to read a template 50 containing filters for status information. The configuration reader 110, 210 can be a separate device or simply implemented as a software module. The configuration reader 110, 210 sets the appertaining parameters for reporting on the medical apparatus 101, 201, thereby causing the status information 60 that is returned to the centralized status system 20 to be filtered according to the template or rules 50 received. The template or rules 50 may be implemented according to, e.g., a query language.

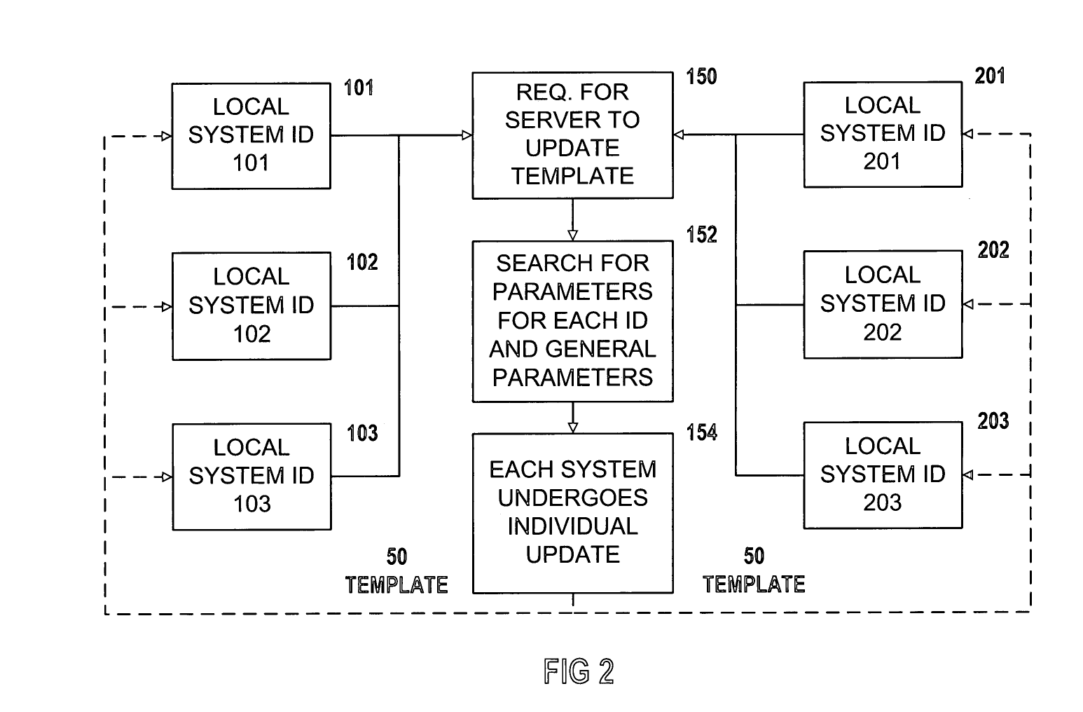

FIG. 2 illustrates an exemplary implementation in which six medical apparatuses are shown having local system identifiers as follows: 101, 102, 103, 201, 202 and 203.

As illustrated in FIG. 2, the centralized system 20 receives a request for the server to update a template 150 on one or more of the medical apparatuses 101-103, 201-203. This request could be initiated by an individual medical apparatus 101 or its associated configuration reader 110 and sent to the centralized system 20, and could be designed so that it is initiated upon installation of the apparatus 101, upon an express request from the apparatus 101, upon each startup of the apparatus, or according to some predetermined schedule (timer), user request, or other criteria. The centralized system would then send a copy of the common template 50 to only the configuration reader 110 of the requesting apparatus 101.

However, the request for the server to update the templates 150 could also be initiated at the centralized system 20 as well according to any of the events or schedules noted in the previous paragraph.

In the above example, the centralized system 20 sends a common template 50 to all apparatuses 101-103, 201-203, and the intelligence for determining how parameters of the template 50 are set on a specific apparatus, e.g., 101, is contained within the associated configuration reader, e.g., 110. However, it is also possible that the centralized system 20 is responsible for sending an appropriate parsed template 50 for a specific apparatus 101 containing only the settings for that apparatus 101.

In order to handle both the general parameters (generic configuration parameter values) as well as the specific parameters (criteria-specific parameter values) for both machines, a search is performed 152 for the respective general and criteria-specific parameters. As an example, if it is desired to update a particular configuration element Z to one particular criteria-specific parameter value <new value 1> on all local systems having an identifier beginning with “2”, and to update this configuration element Z to another particular generic configuration parameter value <new value 2> on all other systems, then in this case, the following update template 50 may be sent to all systems:

| Product ID | Configuration Item | Configuration Value |
|---|---|---|
| 2** | Z | <new value 1> |
| * | Z | <new value 2> |

The asterisk symbol may be utilized as a wildcard symbol that indicates a match with any value. By way of example, using a decimal-based identification system for the wildcard, a configuration reader on each of the systems having IDs 201-203 would match its respective local ID with the wildcarded product ID 2** in the update template and would update the value for the configuration item Z to <new value 1>. The systems with the IDs 101-103 would match the local ID with the product ID * and would update the value for he configuration item Z to <new value 2>. The use of the decimal-based wild-carding is described only by way of example, and any known scheme could be used, e.g., one based on binary, hexadecimal, octal, ASCII, structured data record, or any other criteria known to one of skill in the art. A match would be determined by matching the non-wildcard portions.

According to the above identified scheme, the configuration reader, e.g., 110, would stop processing the table parameter/configuration item Z in the update template once a match has been made. It would thus be possible to deploy one and the same configuration 50 on all installed systems 101-103, 201-203 of a particular type, but each system (dependent on its ID—in the present case it is the material serial number) would be able to be configured differently. The mechanisms used to create and update the contents of the template can be any well-known mechanisms that could include text editors (for text-based files), database applications, or any other mechanism.

The above described system focuses on the use of discrimination based on a unique system/device ID or serial number. However, it is also possible that other mechanisms for discrimination could be utilized. For example, an identifier could be used that identifies, e.g., an operating system platform, a system location, a company location, or any other attribute or criteria, as illustrated by the table below.

| Type | Serial No. | Platform | Country | Customer |
|---|---|---|---|---|
| VA15A- | 201- | IBM- | US- | |

Thus, using the format of the example parameter table above, such a table could be constructed as follows:

| Identifier | Configuration Item | Configuration Value |
|---|---|---|
| VA15A-*-IBM-* | Z | <new value 1> |
| * | Z | <new value 2> |

This would indicate that all VA15A type apparatuses using an IBM-based platform in any country would have configuration item Z set to <new value 1> and all others would have configuration item Z set to <new value 2>. In this way, a maximum of configuration flexibility can be realized.

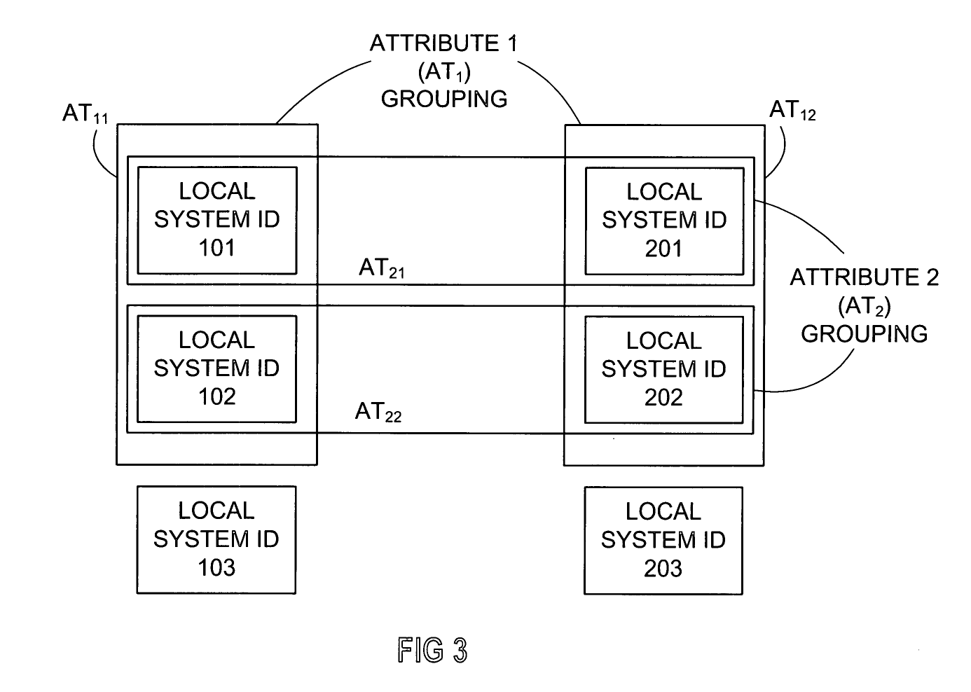

FIG. 3 illustrates a generalized attribute grouping based on two attributes. By way of example, AT₁ could represent a hardware platform characteristic/attribute, having values of AT₁₁ (IBM) and AT₁₂ (FSC). Therefore, systems 101 and 102 run on an IBM platform, and systems 201 and 202 run on an FSC platform. AT₂ could represent an imaging type platform characteristic/attribute, having values of AT₂₁ (film) and AT₁₂ (digital sensor). Therefore, systems 101 and 202 utilize film, and systems 102 and 202 utilize a digital sensor. Systems 103 and 203, as illustrated in FIG. 3 have no association with either attribute AT₁, AT₂, and therefore would be treated separately and could be addressed by their serial number. The fact that systems 101, 102, 201 and 202 are associated with 2 attributes does not mean that they could not be additionally addressed individually according to their serial numbers.

As noted above, the invention can also broadly encompass other operations (besides the forwarding of messages) according to the criteria-specific configuration parameter values, such as customizing a restart policy, that may, for example, involve a watchdog application.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

TABLE OF REFERENCE CHARACTERS

| | |
|---|---|
| 10 | reporting system |
| 20 | centralized status system |
| 50 | template or reporting rules |
| 60 | status information |
| 101, 102, | medical apparatus/local system |
| 103, 201, | |
| 202, 203 | |
| 150 | update request |
| 152 | parameter search |
| 154 | individual update |

What is claimed is:

1. A method for providing generic configuration parameter values and criteria-specific parameter values to a remote device by a centralized system, comprising:
generating a template comprising generic configuration parameter values as well as criteria-specific configuration parameter values based on a predetermined criteria;
updating a parameter in the remote device according to the criteria-specific configuration parameter values if the device meets the predetermined criteria, and according to the generic configuration parameter values otherwise;
generating an event by the remote device;
determining one or more actions to take with respect to the event based on the parameter value that may be either a generic configuration parameter value or a criteria-specific configuration parameter value; and
sending the event by the remote device to the centralized system if the one or more actions include an action of sending the event to the centralized system.

2. The method according to claim 1, wherein the remote device is a medical apparatus.

3. The method according to claim 1, wherein the predetermined criteria is a unique device identifier or serial number.

4. The method according to claim 1, further comprising:
sending the template from the centralized system to a configuration reader associated with the remote device; and
parsing the template by the configuration reader to determine specific parameter settings for a given machine; and
providing the updated parameters for the step of updating.

5. The method according to claim 1, further comprising:
generating a new version of the template from an old version of the template;
storing the old version of the template in a history file; and
storing an index identifying the new version and the old version.

6. The method according to claim 5, further comprising:
requesting, by a user, the old version of the template to be used as the template; and
utilizing the old template as the template in response to the request.

7. The method according to claim 1, further comprising:
initiating the updating by an event selected from the group consisting of a remote device installation, the expiration of a timer, or a user request.

8. The method according to claim 7, wherein the initiating event occurs at the remote device.

9. The method according to claim 7, wherein the initiating event occurs at the centralized system.

10. The method according to claim 1, further comprising:
configuring the predetermined criteria to be represented as at least one of an ASCII, decimal, binary, octal, hexadecimal, or structured data record value.

11. The method according to claim 1, further comprising:
including wildcard values in the represented predetermined criteria; and
utilizing the criteria-specific configuration parameter value on all systems that match non-wildcard values of the predetermined criteria.

12. The method according to claim 1, further comprising:
editing the template with an auxiliary program by a customer to produce a technical environment according to its own requirements.

13. The method according to claim 1, further comprising:
displaying a help message in response to a user query with a flexible query help program.

14. A system for monitoring the status of remote devices, comprising:
a centralized system comprising a template containing generic configuration parameter values as well as criteria-specific configuration parameter values based on a predetermined criteria;
a remote device attached to the centralized system via a communications link;
a communication module configured to move the template from the centralized system to the remote device via the communications link;
a configuration reader having an input for receiving the template and configured to update a parameter in the remote device according to the criteria-specific configuration parameter values if the device meets the predetermined criteria, and according to the generic configuration parameter values otherwise;
an event generator of the remote device that generates events related to the remote device;
a filter mechanism configured to determine one or more actions to take with respect to the event based on the parameter value that may be either a generic configuration parameter value or a criteria-specific configuration parameter value; and
a transmitter for sending the event by the remote device to the centralized system if the one or more actions include an action of sending the event to the centralized system.

15. The system according to claim 14, wherein the remote device is a medical apparatus.

16. The system according to claim 14, wherein the predetermined criteria is a unique device identifier or serial number.

17. The system according to claim 14, further comprising an editor for editing the template by a customer to produce a technical environment according to its own requirements.

18. A method for providing generic configuration parameter values and criteria-specific parameter values to a remote device by a centralized system, comprising:
generating a template comprising generic configuration parameter values as well as criteria-specific configuration parameter values based on a predetermined criteria;
updating a parameter in the remote device according to the criteria-specific configuration parameter values if the device meets the predetermined criteria, and according to the generic configuration parameter values otherwise;
determining one or more actions to take on the remote device based on the parameter value that may be either a generic configuration parameter value or a criteria-specific configuration parameter value; and
performing the one or more actions by the remote device if either the generic configuration parameter value or the criteria-specific configuration parameter value indicates that the remote device is to do so.

19. The method according to claim 18, wherein the one or more actions relates to a restart policy of the remote system.
